(19) United States
(12) Patent Application Publication
(10) Pub. No.: US 2007/0146794 A1
(43) Pub. Date: Jun. 28, 2007

(54) Descreening and detail enhancement for scanned documents

(75) Inventors: Mohamed Nooman Ahmed, Louisville, KY (US); Steven Frank Weed, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/317,180

(22) Filed: Dec. 23, 2005

(51) Int. Cl. G06K 15/00

(52) U.S. Cl. 358/3.06; 358/3.12; 358/3.11

(57) ABSTRACT

A method and apparatus for processing a digital image to reduce moiré artifacts while preserving or improving detailed features. Pixels may be categorized as halftone and/or detail pixels and filtered accordingly. A pixel may be categorized as halftone if intensity values over a first window laid over that pixel vary by less than a first predetermined threshold. A descreen filter may be applied to halftone pixels. The remaining pixels that are not categorized as halftone pixels are analyzed as potential text elements. A PTE may be categorized as a detail pixel if intensity values over a second window laid over that pixel vary by more than a second predetermined threshold. The second window may be smaller than the first window. A sharpening filter may be applied to detail pixels.

### BACKGROUND

Color imaging devices sometimes use halftone screens to combine a finite number of colors and produce, what appears to the human eye, many shades of colors. The halftone process converts different tones of an image into dots and clusters of dots of a few colors. In general, halftone screens of as few as three colors may suffice to produce a substantial majority of visible colors and brightness levels. For many color imaging devices, these three colors comprise cyan, magenta, and yellow. These three colors are subtractive in that they remove unwanted colors from white light (e.g., a sheet of paper). The yellow layer absorbs blue light, the magenta layer absorbs green light, and the cyan layer absorbs red light. In many cases, a fourth color, black, is added to deepen the dark areas and increase contrast.

In order to print different colors, they are separated into several monochrome layers for different colorants, each of which are then halftoned. Thresholding with halftone screens converts colorant values into spatial dot patterns. The resolution of the halftone screen may be expressed in lines per inch (LPI) and is distinguishable from the number of dots per inch (DPI) that are reproducible by an image forming device. In many cases, these monochrome halftone screens are overlaid at different angles to reduce interference effects. The screen resolution that is used for each halftone layer is usually sufficient to produce a continuous tone when viewed by the human eye.

Digital scanning of halftone images sometimes produces unwanted effects such as moiré patterns and blurred edges. Blurred edges are most noticeable with fine features, such as text, and may result from limited scan resolution or scattering of light from the scanner's illumination source. A moiré pattern is generally defined as an interference pattern created when two grids (halftone patterns in the case of color printers) are overlaid on one another. The moiré effect is more pronounced when the grids are at certain angles or when they have slightly different mesh sizes. In the case of scanned images, moiré patterns may be caused by differences in resolution between the scanner and the ordered halftone screen patterns of the original image. Moiré effects are often more noticeable over large halftone areas and usually appear as unwanted spotty or checkerboard patterns.

Blurring (e.g., low pass) filters may remove moiré effects at the expense of making blurred edges and details appear even more indistinct. Conversely, the appearance of blurred details can be improved using conventional sharpening (e.g., high pass or unsharp mask) filters at the expense of making moiré effects more pronounced. Adaptive filters may be customized to account for the screen frequencies in the original document. However, both the detection of the input halftone frequencies and the frequency-domain filtering itself can require significant computational effort. Thus, existing techniques may not adequately suppress interference effects while preserving or sharpening fine detail features.

### SUMMARY OF THE INVENTION

Embodiments disclosed herein are directed to digital image processing algorithms to reduce interference artifacts while preserving or improving detailed features. Digital images comprise a plurality of pixels characterized by one or more pixel intensities. The algorithms disclosed herein examine pixel intensity variations to classify pixels according to their type. Then, different filters may be applied to the different pixel types. For instance, smoothing or descreening filters may be applied to areas characterized by low intensity variations while sharpening filters may be applied to areas characterized by high intensity variations.

Thus, for each pixel, a first action may comprise determining whether the magnitude of pixel intensity variations over a first window of a first size applied at each pixel satisfies a first predetermined condition. Then, those pixels satisfying the first predetermined condition are placed in a first category. As an example, a pixel may satisfy the first predetermined condition if pixel intensity variations over the first window vary by less than a predetermined threshold. Pixel intensity variations may be measured by comparing intensities summed across rows, columns, or diagonals of the first window.

Pixels that do not satisfy the first predetermined condition may then be analyzed to determine if the magnitude of pixel intensity variations over a second window of a second size applied at each of these pixels satisfies a second predetermined condition. Again, as an example, a pixel may satisfy the second predetermined condition if pixel intensity variations over the window of the second size vary by more than a predetermined threshold. Pixel intensity variations may be measured by comparing intensities of pixel pairs disposed on opposite sides or opposite corners of the second window. Further conditions may be imposed on pixel intensity variations, including, for example, spatial correlation, in order to further distinguish text and line edges from halftone dot clusters. Window sizes may be associated with the filters to be applied. For example, to minimize artifacts, windows would typically be at least as large as the associated filters, where filter sizes are determined by the extent of pixel correction desired, as will be understood by those skilled in the art.

### BRIEF DESCRIPTION OF THE DRAWINGS

FIG. 1 is a perspective view of one embodiment of a computing system in which the present invention may be implemented;

FIG. 2 is a functional block diagram of one embodiment of a computing system in which the present invention may be implemented;

FIG. 3 is an exemplary digital representation of an image comprising pixels of different types that may be processed according to embodiments of the present invention;

FIG. 4 is an exemplary flow diagram outlining a classification and filtering technique according to one embodiment of the present invention;

FIG. 5 is an exemplary pixel intensity window that may be used to classify halftone pixels according to one embodiment of the present invention;

FIG. 6 is an exemplary pixel intensity window that may be used to classify detail pixels according to one embodiment of the present invention;

FIGS. 7A and 7B are exemplary smoothing filters that may be used to descreen halftone pixels according to one embodiment of the present invention; and

FIGS. 8A and 8B are exemplary sharpening filters that may be used to sharpen detail pixels according to one embodiment of the present invention.

### DETAILED DESCRIPTION

The various embodiments disclosed herein are directed to devices and methods for classifying and filtering regions of a digital image to remove artifacts from halftone areas while preserving or sharpening detail features. The process may be applied to some or all pixels of an image and involves classifying pixels as belonging to one or more categories. For example, a pixel may be classified as belonging to a halftone category or a detail category. Pixels that are classified in a given category may be omitted from further classification analysis. Appropriate filtering may then be applied to pixels according to their classification.

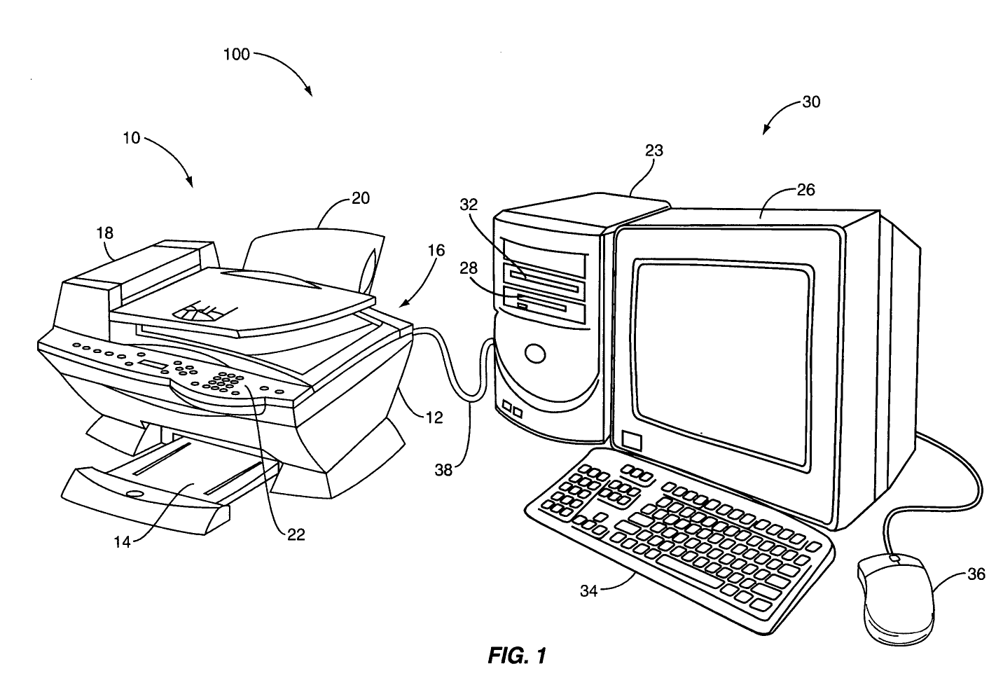

The processing techniques disclosed herein may be implemented in a variety of computer processing systems. For instance, the disclosed image processing technique may be executed by a computing system 100 such as that generally illustrated in FIG. 1. The exemplary computing system 100 provided in FIG. 1 depicts one embodiment of a representative multifunction device, such as an All-In-One (AIO) device, indicated generally by the numeral 10 and a computer, indicated generally by the numeral 30. A desktop computer 30 is shown, but other conventional computers, including laptop and handheld computer devices, such as personal digital assistants, are also contemplated. In the embodiment shown, the multifunction device 10 comprises a main body 12, at least one media tray 20 adapted to hold a stack of print media, a flatbed (or feed-through as known in the art) scanner 16 comprising a document handler 18, a media output tray 14, and a user interface panel 22. The multifunction device 10 is adapted to perform multiple home or business office functions such as printing, faxing, scanning, and/or copying. Consequently, the multifunction device 10 includes further internal components not visible in the exterior view shown in FIG. 1.

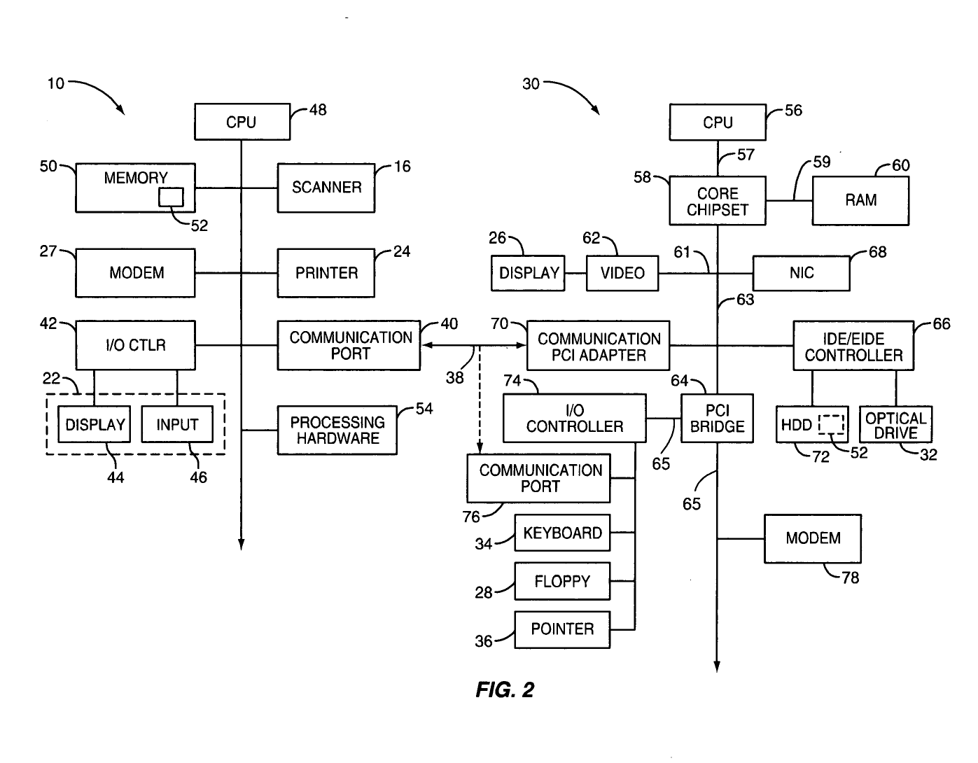

The exemplary computing system 100 shown in FIG. 1 also includes an associated computer 30, which may include a CPU tower 23 having associated internal processors, memory, and circuitry (not shown in FIG. 1, but see FIG. 2) and one or more external media drives. For example, the CPU tower 23 may have a floppy disk drive (FDD) 28 or other magnetic drives and one or more optical drives 32 capable of accessing and writing computer readable or executable data on discs such as CDs or DVDs. The exemplary computer 30 further includes user interface components such as a display 26, a keyboard 34, and a pointing device 36 such as a mouse, trackball, light pen, or, in the case of laptop computers, a touchpad or pointing stick.

An interface cable 38 is also shown in the exemplary computing system 100 of FIG. 1. The interface cable 38 permits one- or two-way communication between the computer 30 and the multifunction device 10. When coupled in this manner, the computer 30 may be referred to as a host computer for the multifunction device 10. Certain operating characteristics of the multifunction device 10 may be controlled by the computer 30 via printer or scanner drivers stored on the computer 30. For instance, scan jobs originated on the computer 30 may be executed by the multifunction device 10 in accordance with scan resolution and filter settings that may be set on the computer 30. Where a two-way communication link is established between the computer 30 and the multifunction device 10, information such as scanned images or incoming fax images may be transmitted from the multifunction device 10 to the computer 30.

With regards to the processing techniques disclosed herein, certain embodiments may permit operator control over image processing to the extent that a user may select certain image areas or filter settings that are used in the image conversion. Accordingly, the user interface components such as the user interface panel 22 of the multifunction device 10 and the display 26, keyboard 34, and pointing device 36 of the computer 30 may be used to control various processing parameters. As such, the relationship between these user interface devices and the processing components is more clearly shown in the functional block diagram provided in FIG. 2.

FIG. 2 provides a simplified representation of some of the various functional components of the exemplary multifunction device 10 and computer 30. For instance, the multifunction device 10 includes the previously mentioned scanner 16 as well as an integrated printer 24, which may itself include a conventionally known ink jet or laser printer with a suitable document transport mechanism. Interaction at the user interface 22 is controlled with the aid of an input/output (I/O) controller 42. Thus, the I/O controller 42 generates user-readable graphics at a display 44 and interprets commands entered at a keypad 46. The display 44 may be embodied as an alphanumeric LCD display and keypad 46 may be an alphanumeric keypad. Alternatively, the display and input functions may be accomplished with a composite touch screen (not shown) that simultaneously displays relevant information, including images, while accepting user input commands by finger touch or with the use of a stylus pen (not shown).

The exemplary embodiment of the multifunction device 10 also includes a modem 27, which may be a fax modem compliant with commonly used ITU and CCITT compression and communication standards such as the ITU-T series V recommendations and Class 1-4 standards known by those skilled in the art. The multifunction device 10 may also be coupled to the computer 30 with an interface cable 38 coupled through a compatible communication port 40, which may comprise a standard parallel printer port or a serial data interface such as USB 1.1, USB 2.0, IEEE-1394 (including, but not limited to 1394a and 1394b) and the like.

The multifunction device 10 may also include integrated wired or wireless network interfaces. Therefore, communication port 40 may also represent a network interface, which permits operation of the multifunction device 10 as a stand-alone device not expressly requiring a host computer 30 to perform many of the included functions. A wired communication port 40 may comprise a conventionally known RJ-45 connector for connection to a 10/100 LAN or a 1/10 Gigabit Ethernet network. A wireless communication port 40 may comprise an adapter capable of wireless communications with other devices in a peer mode or with a wireless network in an infrastructure mode. Accordingly, the wireless communication port 40 may comprise an adapter conforming to wireless communication standards such as Bluetooth®, 802.11x, 802.15 or other standards known to those skilled in the art.

The multifunction device 10 may also include one or more processing circuits 48, system memory 50, which generically encompasses RAM and/or ROM for system operation and code storage as represented by numeral 52. The system memory 50 may suitably comprise a variety of devices known to those skilled in the art such as SDRAM, DDRAM, EEPROM, Flash Memory, and perhaps a fixed hard drive. Those skilled in the art will appreciate and comprehend the advantages and disadvantages of the various memory types for a given application.

Additionally, the multifunction device 10 may include dedicated image processing hardware 54, which may be a separate hardware circuit or may be included as part of other processing hardware. For example, image processing and filtering may be implemented via stored program instructions for execution by one or more Digital Signal Processors (DSPs), ASICs or other digital processing circuits included in the processing hardware 54. Alternatively, stored program code 52 may be stored in memory 50, with the image processing techniques described herein executed by some combination of processor 48 and processing hardware 54, which may include programmed logic devices such as PLDs and FPGAs. In general, those skilled in the art will comprehend the various combinations of software, firmware, and/or hardware that may be used to implement the various embodiments described herein.

FIG. 2 also shows functional components of the exemplary computer 30, which comprises a central processing unit (“CPU”) 56, core logic chipset 58, system random access memory (“RAM”) 60, a video graphics controller 62 coupled to the aforementioned video display 26, a PCI bus bridge 64, and an IDE/EIDE controller 66. The single CPU block 56 may be implemented as a plurality of CPUs 56 in a symmetric or asymmetric multi-processor configuration.

In the exemplary computer 30 shown, the CPU 56 is connected to the core logic chipset 58 through a host bus 57. The system RAM 60 is connected to the core logic chipset 58 through a memory bus 59. The video graphics controller 62 is connected to the core logic chipset 58 through an AGP bus 61 or the primary PCI bus 63. The PCI bridge 64 and IDE/EIDE controller 66 are connected to the core logic chipset 58 through the primary PCI bus 63. A hard disk drive 72 and the optical drive 32 discussed above are coupled to the IDE/EIDE controller 66. Also connected to the PCI bus 63 are a network interface card (“NIC”) 68, such as an Ethernet card, and a PCI adapter 70 used for communication with the multifunction device 10 or other peripheral device. Thus, PCI adapter 70 may be a complementary adapter conforming to the same or similar protocol as communication port 40 on the multifunction device 10. As indicated above, PCI adapter 70 may be implemented as a USB or IEEE 1394 adapter. The PCI adapter 70 and the NIC 68 may plug into PCI connectors on the computer 30 motherboard (not illustrated). The PCI bridge 64 connects over an EISA/ISA bus or other legacy bus 65 to a fax/data modem 78 and an input-output controller 74, which interfaces with the aforementioned keyboard 34, pointing device 36, floppy disk drive (“FDD”) 28, and optionally a communication port such as a parallel printer port 76. As discussed above, a one-way communication link may be established between the computer 30 and the multifunction device 10 or other printing device through a cable interface indicated by dashed lines in FIG. 2.

Relevant to the digital image processing techniques disclosed herein, digital images may be read from a number of sources in the computing system 100 shown. For example, hard copy images may be scanned by scanner 16 to produce a digital reproduction. Alternatively, the digital images may be stored on fixed or portable media and accessible from the HDD 72, optical drive 32, floppy drive 28, or accessed from a network by NIC 68 or modem 78. Further, as mentioned above, the various embodiments of the digital image processing techniques may be implemented within a device driver, program code 52, or software that is stored in memory 50, on HDD 72, on optical discs readable by optical disc drive 32, on floppy disks readable by floppy drive 28, or from a network accessible by NIC 68 or modem 78. Those skilled in the art of computers and network architectures will comprehend additional structures and methods of implementing the techniques disclosed herein.

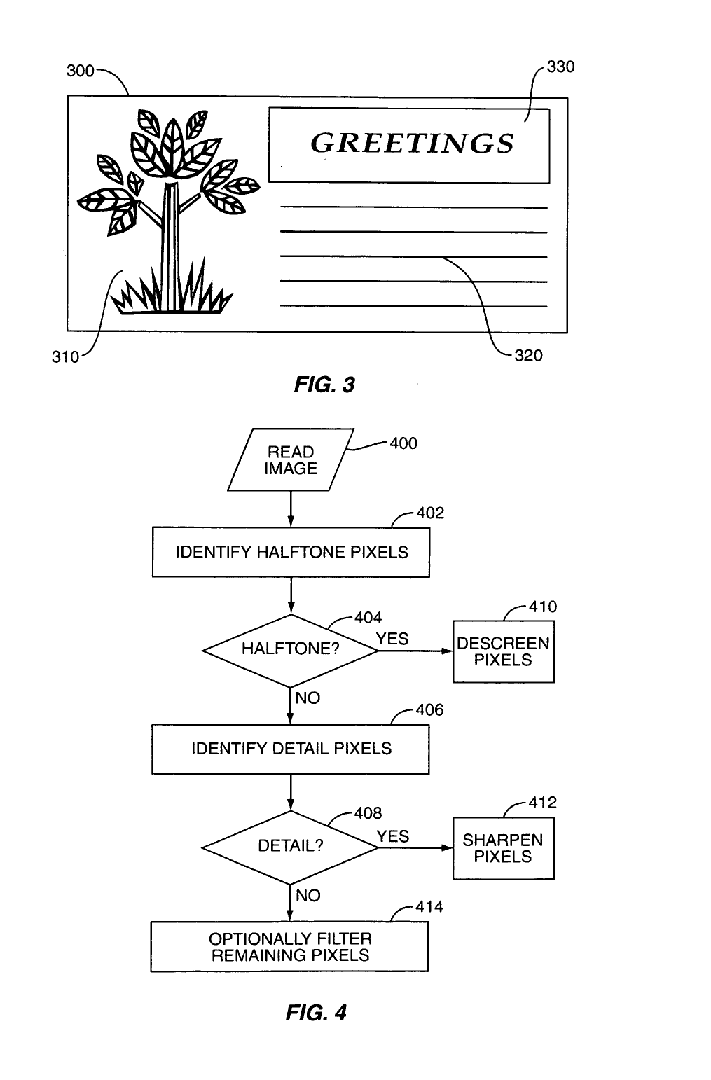

Digital images are comprised of a plurality of pixels. For scanned images, such as the document 300 shown in FIG. 3, each pixel represents a color and/or brightness sample from a finite area of the original detected by an optical, sensor during the scan process. The number of pixels produced by scanning a document will vary depending on the scan resolution. Regardless, each pixel of the scanned document 300 may be classified according to an area of the image in which that pixel is located. For example, the scanned document 300 shown in FIG. 3 includes a bitmap image 310, fine detail or text 320, and a halftone area 330.

A scanner may produce different effects when scanning these areas of a document. For example, edges of fine detail features 320 may appear jagged while moiré patterns may appear in a halftone area 330. Accordingly, in one embodiment of the image filtering technique, pixels are classified according to the area in which they are located. Then an appropriate filter may be applied to pixels according to their classification.

The process shown in FIG. 4 generally outlines one method of performing this classification and filtering technique. This approach seeks to distinguish and classify halftone areas and detail areas of an image for the purpose of applying local filtering that is appropriate for that region. A multi-resolution analysis is performed in the process shown. First, the image or a portion of an image is read (block 400) as it is scanned by scanner 16 or from one of the plurality of network, storage, and/or memory devices shown in FIG. 2. In block 402, a large-scale analysis of the image looks for halftone or pseudo-constant color areas of an image. After this initial analysis, pixels that do not definitively fall in the halftone or pseudo-constant color category (block 404) are analyzed to determine if they should be classified as text or detailed edges (block 406). Once all pixels and image areas are appropriately classified, the pixels are filtered according to their classification. For example, halftone/constant areas may be smoothed (block 410) and the detailed areas may be sharpened (block 412). Areas not falling in either category as determined in block 408, may be left alone or nominally filtered (block 414). Additional pixel classification categories may be used to select alternative filter coefficients or image processing algorithms.

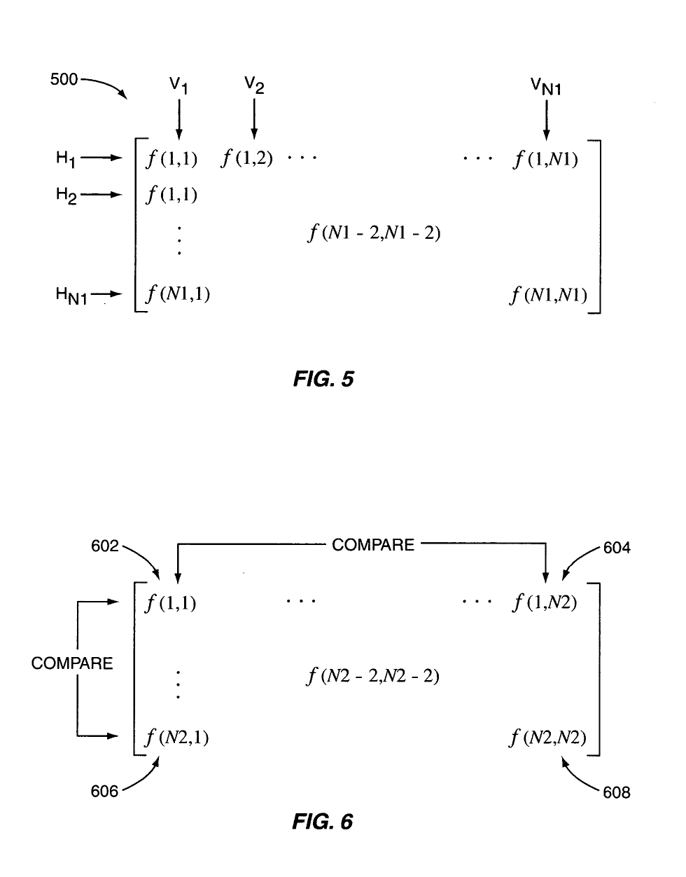

In block 402, the algorithm looks for more than gradual changes in color intensity over a fixed N1×N1 window in the vicinity of each pixel in the image. As an example, the pixel intensities for a N1×N1 pixel window 500 that is laid over a pixel in an image is shown in FIG. 5 where the intensity of any pixel x,y in the window is represented as f(x,y). It should be noted that the window may be laid over the pixel of interest in a variety of ways. For instance, the pixel of interest may be the upper left pixel at position (1,1) or may be at a central position in the window. Other positions are possible, but a consistent pixel position within the moving N1×N1 window may be optimal.

The sum of all intensities for each row H and each column V are calculated. In the present example, N1 row sums Hᵢ (for i=1→N1) and N1 column sums Vᵢ (for i=1→N1) are calculated. Next, the maximum and minimum sums are determined and labeled Hmin, Hmax, Vmin, and Vmax. Further, the sum of intensities across the two major diagonals D1, D2 are also calculated. If the differences between the Hᵢ, Vᵢ, D1 and D2 values are small, this indicates small intensity changes exist over the entire window.

In equation form, the pertinent values may be represented by:

$${H}_{i} = {\sum }_{k = 1}^{N 1} f ( i , k ) for i = 1 , 2 … , N 1$$

$${V}_{i} = {\sum }_{j = 1}^{N 1} f ( j , i ) for i = 1 , 2 … , N 1$$

$${D}_{1} = {\sum }_{i = 1}^{N 1} f ( j , i )$$

$${D}_{2} = {\sum }_{i = 1}^{N 1} f ( i , N + 1 - i ) . \\ H max = max ( {H}_{i} ) for i = 1 , 2 … , N 1$$

$$H min = min ( {H}_{i} ) for i = 1 , 2 … , N 1$$

$$V max = max ( {V}_{i} ) for i = 1 , 2 … , N 1$$

$$H min = min ( {V}_{i} ) for i = 1 , 2 … , N 1$$

Then, the following inequalities may be used to affirmatively classify pixels as belonging to the halftone category. If:
Hmax−Hmin≦T1 and
Vmax−Vmin≦T1 and
|D1−D2|≦T2,
where T1 and T2 are predetermined threshold values, then the pixel of interest may be classified as being in a halftone category. The threshold values may be adjusted as desired to control the amount of color variation that is needed to fall outside of the halftone category. In general, however, this portion of the algorithm is looking for something more than gradual changes in color intensity over a relatively large N1×N1 window. The higher the threshold values, the more color variation is allowed for the halftone category. Thus, pixels in areas characterized by slow color changes may still be classified in the halftone category. Furthermore, the size of the N1×N1 window may be adjusted to control the rate of change that is needed to classify pixels as halftone. In one embodiment, provided an appropriately sized descreening filter is used, a 17×17 window may be used for scans produced at 600 DPI.

Pixels that are not classified as halftone pixels may be classified as potential text elements (PTE). Notably, the number of pixels analyzed during this block 406 may be less than that analyzed in the halftone classification block 402, particularly where some of the original pixels have been classified as halftone pixels. Thus, the total processing required may be reduced. A smaller window of N2×N2 (where N2<N1) pixels may be considered for block 406 because the algorithm is searching for fine details. This is in contrast to the initial analysis (block 402) described above where gradual changes over larger areas were detected. In one embodiment, only the pixels at the side edges or top and bottom edges of the smaller window may be considered. In essence, block 406 determines whether there are any substantial changes in intensity from one side of this window to the other (or from top to bottom). For example, an N2×N2 window such as that shown in FIG. 6 may be laid over a PTE.

In one embodiment, the intensities of pixels at the left side of this window are compared to the intensities of the pixels at the right side of this window. In all, N2 pairs of intensity values are compared in the present example. If there is a substantial change in pixel intensity across the window, the pixel of interest is classified as a detail pixel. For example, if |f(1,1)−f(1,N2)|≧T3, where T3 is yet another predetermined threshold, the pixel of interest is classified as a detail pixel. The same comparison may be made for the pixels at the top and bottom of this smaller window. Thus, another N2 pairs of intensity values may be compared. Again, as an example, if |f(1,1)−f(N2,1)|≧T3, the pixel of interest may be classified as a detail pixel. The pixels at the opposite corners 602, 608 and 604, 606 of this window (or a slightly larger N3×N3 window, where N3>N2) may also be compared to look for substantial changes in intensity. In equation form, this threshold operation may be expressed as the following:
If |f(N2+1−i,1)−f(N2+1−i,N2)|≧T3 for i=1,2, . . . ,N2 or
If |f(1,N2+1−i)−f(N2,N2+1−i)|≧T3 for i=1,2, . . . ,N2 or
If |f(1,1)−f(N2,N2)|≧T3 or
If |f(N2,1)−f(1,N2)|≧T3,
then the pixel of interest may be classified as a detail pixel. In one embodiment, a 5×5 window has been found to work well for typical text sizes scanned at 600 DPI. For the corer pixel 602, 608 and 604, 606 comparisons, a slightly larger 7×7 window has been used successfully. Larger windows may be more appropriate for higher resolution scans.

Once pixels are classified as indicated above, the halftone pixels may be filtered using a spatial smoothing mask. Spatial domain masks are known in the art and are applied as follows. For a 3×3 mask having the following values

| | | |
|---|---|---|
| w1 | w2 | w3 |
| w4 | w5 | w6 |
| w7 | w8 | w9 |

and the intensity values for the pixels under the mask at any given location x,y being

| | | |
|---|---|---|
| z1 | z2 | z3 |
| z4 | z5 | z6 |
| z7 | z8 | z9 |

then the new intensity value for pixel x,y is given by
f_{new}(x,y)=w1*z1+w2*z2+w3*z3+w4*z4+w5*z5+w6*z6+w7*z7+w8*z8+w9*z9.

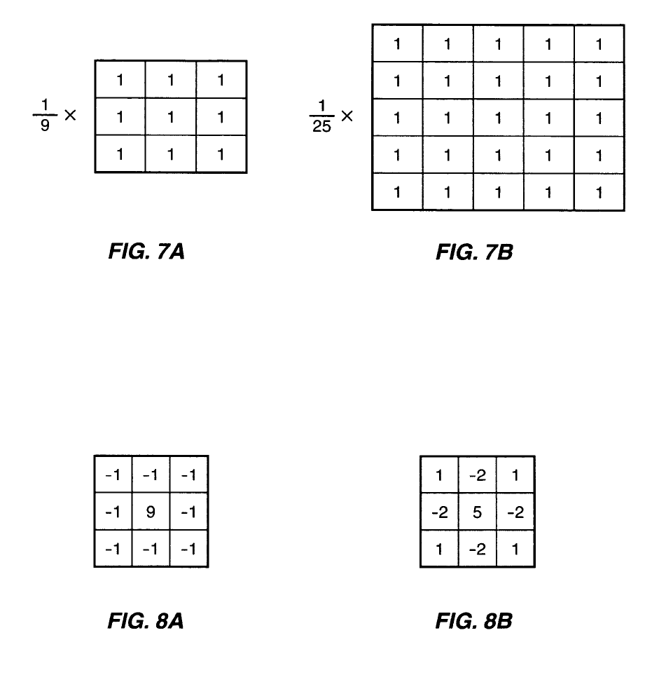

Some example smoothing masks that may be applied to the halftone/constant pixels include a 3×3 averaging mask or a 5×5 averaging mask, such as those shown in FIGS. 7A and 7B. These types of smoothing masks may operate to remove or reduce moiré effects in halftone areas. Hence, these filters may also be referred to as descreen filters. Furthermore, a sharpening mask may be applied to all detail pixels. Some example sharpening masks include the 3×3 masks shown in FIGS. 8A and 8B. Sharpening filters may enhance edge boundaries, thus making detailed items such as text more clear. Pixels that were not classified as being either halftone or detail may be left as is or filtered using conventionally known sharpening or softening filters. Furthermore, as indicated above, the various thresholds, window sizes, and filter types may be user-adjustable to optimize the algorithm for different image sizes, image qualities, original types, halftone screen frequencies and scan resolutions.

The present algorithm may be carried out in other specific ways than those herein set forth without departing from the scope and essential characteristics of the invention. For example, pixels may be classified in two categories: halftone and detail. Other categories of pixel types may be established through alteration of the window sizes and threshold settings. In certain cases, it may be desirable to capture raw scanned image data and prevent image filtering to these image areas in an automated fashion. Halftone areas may be distinguished from image areas in that they are characterized by very low color variations over relatively large areas. To account for this, the thresholds in the initial analysis (block 402) may be lowered and the window sizes may be increased to distinguish between halftone areas and images. Then, filtering may be applied to the halftone areas while preserving the image data. The present algorithm permits modification of the operating parameters to account for these types of scenarios. The present embodiments are, therefore, to be considered in all respects as illustrative and not restrictive, and all changes coming within the meaning and equivalency range of the appended claims are intended to be embraced therein.

What is claimed is:

1. A method of processing a digital image having a plurality of pixels characterized by one or more pixel intensities, comprising:
for each pixel in said digital image, determining whether the magnitude of pixel intensity variations over a window of a first size applied at each pixel satisfies a first predetermined condition;
classifying those pixels satisfying the first predetermined condition in a first category;
for pixels not satisfying the first predetermined condition, determining if the magnitude of pixel intensity variations over a window of a second size applied at each of these pixels satisfies a second predetermined condition;
classifying those pixels satisfying the second predetermined condition in a second category;
applying a first filter to pixels classified in the first category; and
applying a second filter to pixels classified in the second category.

2. The method of claim 1, further comprising satisfying the first predetermined condition if the magnitude of pixel intensity variations over the window of the first size falls below a predetermined value.

3. The method of claim 2, wherein determining whether the magnitude of pixel intensity variations over the window of the first size falls below a predetermined value comprises calculating a first diagonal sum as a sum of intensity values for pixels along a first major diagonal of the window and a second diagonal sum as a sum of intensity values for pixels along a second major diagonal of the window and determining whether the difference between first diagonal sum and the second diagonal sum falls below a predetermined threshold.

4. The method of claim 2, wherein determining whether the magnitude of pixel intensity variations over the window of the first size falls below a predetermined value comprises calculating a row sum as a sum of intensity values for each of a plurality of rows of the window and calculating a column sum as a sum of intensity values for each of a plurality of columns of the window and determining whether the difference between a maximum row sum and a minimum row sum or a difference between a maximum column sum and a minimum column sum falls below a predetermined threshold.

5. The method of claim 1, further comprising satisfying the second predetermined condition if the magnitude of pixel intensity variations over the window of the second size exceeds a predetermined value.

6. The method of claim 5, wherein determining whether the magnitude of pixel intensity variations over the window of the second size exceeds a predetermined value comprises determining whether a difference between intensity values of pixels on opposite sides of the window or a difference between intensity values of pixels on opposite corners of the window exceed a predetermined threshold.

7. The method of claim 1, wherein the first and second window sizes are at least as large as the sizes of the first and second filters.

8. The method of claim 1, wherein a pixel satisfies the second predetermined condition if pixel intensity variations over the window of the second size vary by more than a predetermined threshold.

9. A method of processing a digital image having a plurality of pixels characterized by one or more pixel intensities, comprising: categorizing a pixel as a first type of pixel if intensity values over a first window laid over that pixel vary by less than a first predetermined threshold, the first window having a first size;
applying a descreen filter to pixels that are categorized as a pixel of the first type;
for pixels not categorized as a pixel of the first type, categorizing a pixel as a second type of pixel if intensity values over a second window laid over that pixel vary by more than a second predetermined threshold, the second window having a second size that is different than the first size; and
applying a sharpening filter to pixels that are categorized as a pixel of the second type.

10. The method of claim 9, wherein the first window is larger than the second window.

11. The method of claim 9, wherein categorizing a pixel as a first type of pixel if intensity values over the first window laid over that pixel vary by less than a first predetermined threshold comprises calculating a row sum as a sum of intensity values for each of a plurality of rows of the window and calculating a column sum as a sum of intensity values for each of a plurality of columns of the window and determining whether the difference between a maximum row sum and a minimum row sum or a difference between a maximum column sum and a minimum column sum falls below the first predetermined threshold.

12. The method of claim 9, wherein categorizing a pixel as a first type of pixel if intensity values over the first window laid over that pixel vary by less than a first predetermined threshold comprises calculating a first diagonal sum as a sum of intensity values for pixels along a first major diagonal of the window and a second diagonal sum as a sum of intensity values for pixels along a second major diagonal of the window and determining whether the difference between first diagonal sum and the second diagonal sum falls below the first predetermined threshold.

13. The method of claim 9, wherein categorizing a pixel as a second type of pixel if intensity values over a second window laid over that pixel vary by more than a second predetermined threshold comprises determining whether a difference between intensity values of pixels on opposite sides of the window or a difference between intensity values of pixels on opposite corners of the window exceed the second predetermined threshold.

14. The method of claim 9, further comprising permitting adjustment of the first window size, the second window size, the first predetermined threshold, and the second predetermined threshold to adjust the types of image regions that are filtered using the descreen filter and the sharpening filter.

15. A computer readable medium which stores a computer-executable process for processing a digital image, said computer-executable process comprising:
for each pixel in said digital image, classifying a pixel into a halftone category if a magnitude of pixel intensity variations over a window of a first size applied at that pixel is smaller than a first threshold;
for pixels not classified into the halftone category, classifying a pixel into a detail category if a magnitude of pixel intensity variations over a window of a second size applied at that pixel is larger than a second threshold;
applying a smoothing filter to pixels classified in the halftone category; and
applying a sharpening filter to pixels classified in the detail category.

16. The computer readable medium of claim 15, wherein the first window is larger than the second window.

17. The computer readable medium of claim 15, further comprising:
summing intensity values over all rows of the window of the first size to produce a row sum for each row in the window;
summing intensity values over all columns of the window of the first size to produce a column sum for each column in the window;
classifying a pixel into a halftone category if a difference between a maximum and a minimum value of the row sums and a difference between a maximum and a minimum value of the column sums all fall below the first threshold.

18. The computer readable medium of claim 15, further comprising:
summing intensity values over all major diagonals of the window of the first size to produce a diagonal sum for each major diagonal in the window; and
classifying a pixel into a halftone category if a difference between the diagonal sums falls below the first threshold.

19. The computer readable medium of claim 15, further comprising:
classifying a pixel into the detail category if any one of a single difference in intensity values between pairs of pixels located on opposite sides of the window of the second size or a single difference in intensity values between pairs of pixels located on opposite corners of the window of the second size exceed the second threshold.

20. The computer readable medium of claim 15, wherein the computer-executable process is performed entirely within an image forming device.
